(19) United States
(12) Patent Application Publication
(10) Pub. No.: US 2013/0298176 A1
(43) Pub. Date: Nov. 7, 2013

(54) APPARATUS AND METHOD FOR HANDLING INTERACTIVE MEDIA CONTENT REQUESTS USING MOBILE MEDIA MANAGER AND VIRTUAL LOCATION MEDIA SERVERS

(71) Applicant: George Stoikos, Serres (GR)

(72) Inventor: George Stoikos, Serres (GR)

(73) Assignee: AKOO INTERNATIONAL, INC., Rosemont, IL (US)

(21) Appl. No.: 13/464,306

(22) Filed: May 4, 2012

(51) Int. Cl. H04N 21/266

(52) U.S. Cl. 725/93

(57) ABSTRACT

A digital media selection, retrieval and delivery apparatus and method includes a mobile media manager controller disposed in communication with one physical location media server. One or more virtual location media server is embodied in computer readable medium in a computing device are disposed in communication between the media manager controller and different audio-visual playback devices. A user request for a selected media to be played on a selected audio visual device is routed through the mobile media manager controller, and one selected virtual location media server to the specified audio visual device.

### BACKGROUND

The present invention relates, in general, to audio/visual content delivery and broadcast systems and, specifically, to the selection of specific content or media for output on a selected audio/visual device.

Audio/video media content selection and delivery systems come in many forms. Generally speaking, a user via a computer, mobile communication device, etc., can access a source of audio/video content, and then select the desired content for delivery to a specific audio/video device, such as a jukebox system in a bar or restaurant, a computer monitor, the user's mobile device, etc.

For example, a typical audio/video selection and delivery system as shown in Applicants' prior U.S. Pat. Nos^{.} 7,647,613 and 7,797,719.

Applicants' system utilizes a central music server coupled to media content storage, such as music, videos and combinations thereof. A central mobile media manager server is interposed between a wireless communication system, such as the Internet receiving media requests from user devices, such as personal computers, tablet computers, mobile communication devices, such as cellular telephones, etc. and controls the management, selection and output of such selected media content through the central music server to an audio/video display device selected by the user.

The mobile media manager server communicates with a location media server at the display site, such as digital jukebox, etc. A location media server, at the bar or restaurant, controls the display of the selected media content on one of more selected audio/video device in the location, such as one or more display screens or monitors in a bar or restaurant. The location media server, in conjunction with the mobile media management server, can also be employed to direct selected media content to one specific audio/video device from one user and other selected media content from other users to other audio/video devices in the same location.

However, it would be desirable to provide a method and apparatus for expanding Applicants' mobile media manager apparatus and method to support multiple audio/video units which may be located in the same or many different physical locations.

Applicants' prior patented system was also directed to audio-visual devices which were typically just monitors or display screens for visually displaying the audio-visual media selected by a user. A whole new class of audio-visual devices are currently in use which include computer processors, such as so called smart A/Vs, such as internet televisions, game consoles and, in general, tablet computers, smart phones as well as PC's, including laptop and desktop computers.

It would also be desirable to provide a media request selection method and apparatus which enables the user to request a specific digital media to be played at a specific A/V device where the selected A/V device may have additional computer processing capabilities for media storage, time of day playing, playback, and other features.

### SUMMARY

A method for digital content selection and play includes the steps of receiving, by a master media manager controller (MMM), a user request requesting a specific digital media for play on a specific audio-visual playback device, accessing, by the master media manager controller, a store of media content, disposing at least one virtual location media server in communication with the master MMM, the at least one virtual location media server residing in a computer readable medium of a computing device, coupling at least one audio-visual device in communication with the at least one virtual LMS, and transmitting the identified media in the user request by the master MMM through the at least one location media server to the selected audio-visual device for play of the identified media by the selected audio-visual device.

The method further provides a plurality of virtual location media server s and at least one audio-visual device disposed in communication with each virtual location media server.

In the method, the one of virtual LMSs that receives an incoming user request determines if it can service the user request. If yes, the receiving LMS forwards the digital media content specified in the user request to the selected A/V device.

An apparatus for digital content selection of play comprising at least one audio-visual playback device capable of playing audio-visual media, the audio-visual playback device having a distinct identifier, a location media server coupled to the at least one audio-visual playback device for transferring digital media content to a selected at least one audio-visual playback device, a master media manager controller configured for receiving a user request from a user interface separate from the at least one audio-visual playback device, the user request identifying a distinct audio-visual media content and the distinct identifier of the at least one audio-visual playback device, at least one virtual media manager controller embodied in a computer executable medium in a computing device coupled to the master media manager controller, and the at least one virtual media manager controller coupled by a first communication path with the at least one location media server.

A streaming audio-video server can be coupled in communication with the media store and the master mobile media controller, to convert a selected media in a user request to a streaming audio-video format, which is then transferred by the streaming audio-video server through the mobile media controllers or directly to the specified virtual location media server and A/V devices.

### BRIEF DESCRIPTION OF THE DRAWING

The various features, advantages and other uses of the present invention will become more apparent by referring to the following detailed description and drawing in which:

FIG. 1 is a block diagram of an apparatus for handling interactive content requests;

FIG. 2 is a detailed block diagram of the apparatus shown in FIG. 1;

FIG. 3 is a detailed block diagram of the mobile manager shown in FIG. 1;

FIG. 4 is a flow chart of one aspect of a method of operation of the apparatus shown in FIG. 1; and

FIG. 5 is a flow chart of another aspect of a method of operation of the apparatus shown in FIG. 1.

### DETAILED DESCRIPTION

An interactive media request system in a communication network is disclosed for selecting content, such as songs and/or videos, from user requests from a mobile communication device for output by a digital audio-visual playback device.

The term “audio-visual” as referred to herein to encompass audio data, such as music, spoken words, etc., visual data, such as movies, video games, and other visual images, including text, and combinations of audio and visual material simultaneously output to an audio-visual playback device. Thus, it will be understood that although music and music identification data are referred to hereafter, it will be understood that this is by way of example only.

Further, it will be understood that the use of the term digital media will encompass both audio and/or visual data as well as audio and/or visual data identification, such as author name, title, length of play, type of media, etc.

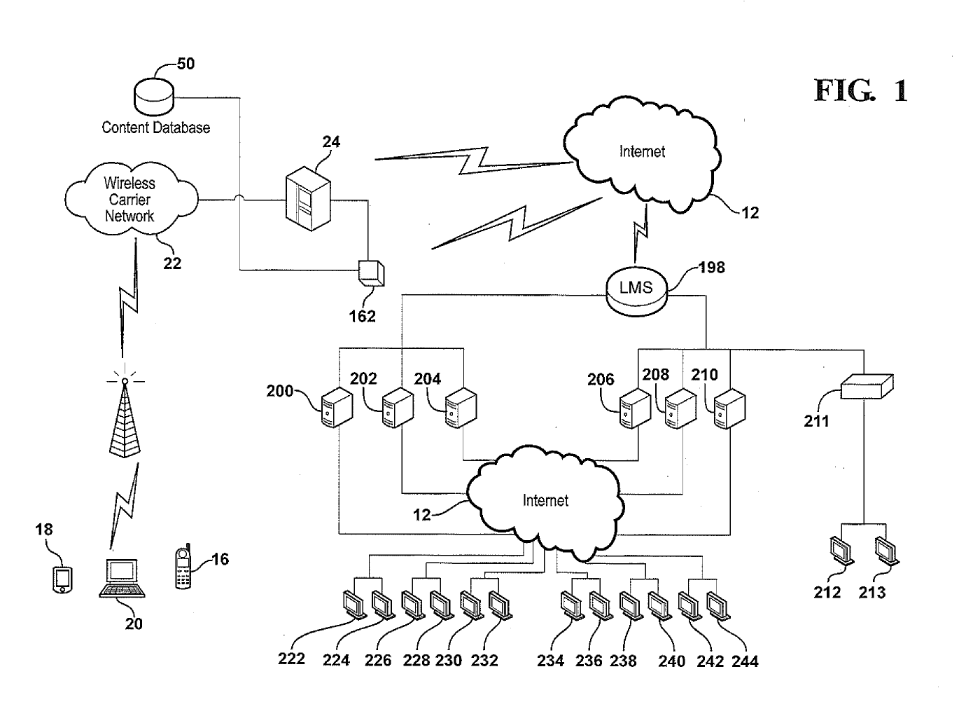

In one aspect shown in FIG. 1, a central management system manages a communication link to mobile stations in a media content network and translates packets in the payloads of SMS, MMS or Internet messages containing specific content selections created by a mobile user located remote from the playback devices. A central Mobile Media Manager (MMM) 24 implemented as a feature of communication link 22, such as a carrier network, which may be implemented as a Short-Message-Service-Center (SMSC) 22 and Mobile-Multimedia-Service-Environment (MMSE) or an Internet network, manages concurrent mobile-originating transmissions representing mobile user selected content or media, such as song selections, designated for public performance from one of a plurality of A/V devices 14.

At least a portion of the carrier network 22 may include wireless communication. The central MMM 24 addresses a media content database 50 via HTTP, for example, that maintains a master set of compressed digital data or media representing a plurality of songs, song associated graphics, song identity information, videos and audio/video (A/V) venue location identification codes, for example. The MMM 24 receives mobile selection information from the carrier network 22 and polls the database 50 to obtain an updated list of registered audio/visual devices 14, to determine content availability from a list of content or music residing on the database 50 and/or the A/V devices 14, and to check the validity of the user request.

Specific content selections initiated by a mobile user 16, 18, 20 including content event or song identity, venue location register and service priority queuing to a specific A/V device 14, received at the central MMM 24 to provide audio or video output in the service, venue or A/V device 14 where the mobile user initiated the selection. The MMM 24 interfacing the carrier network 22 and the A/V network operates on a scheduled peer session interval to authenticate users, determine the value of the billing event and handle submission of user requests. The MMM 24 differentiates the value of the network carrier requests to the billing entity. The MMM 24 communicates to the core network carrier 22 whether a mobile user, i.e., wireless carrier, SMSC, etc., should be billed only after the MMM 24 has verified that a corresponding A/V device 14 is operating, the MMM 24 has verified that the master or the subset of the master set of digital media is available, and the MMM 24 has forwarded the user request designated as a Standard or Priority request to be placed in the network 10 queue.

In FIG. 1, an A/V network is illustrated, by example, as including a master mobile media manager controller (MMM) having a host processor which communicates via HTTP or other data transmission formats through a wireless communication system, such as the Internet 12, hardline, etc., to at least one or a plurality of digital audio-visual playback devices, such as monitors, digital jukeboxes, mobile telephone and tablet computer display screens, smart televisions, etc. The communication format to each A/V device 14 can be via any transmission protocol, such as ADSL, cable modem, WCDMA, UMTS, or LMDS or other data communication protocols.

According to this aspect, a mobile communication device or user interface, typically a mobile wireless communication device, such as a cellular telephone 16, a PDA 18, or a computer 20, as non-limiting examples only, communicates with the communication network 22. The communication link or network 22 may be any type of communication provider either wireless or not, such as, but not limited to, WiFi, Internet, direct cable connection, Ethernet, GSM, GPRS, UMTS, Edge, Token ring etc. Such a network 22 may have as a subset, a Short Message Service Center (SMSC) adapted for short text messaging, an Internet protocol having displayable drop down menus allowing user input selections, or a multimedia service (MMS) providing audio and graphic data.

Although the following example of a wireless content request pertains to a short message service using an SMSC subset of the wireless carrier network 22, it will be understood that similar data input protocols or media selection, such as through drop down menus, may also be employed.

An appropriate SMS address, such as 1414 for example, is entered by the user through the communication device 16, 18, or 20 to identify the MMM 24 service. Text messages formed of UNICODE or ASCII characters are then input by a user through the user interface 16, 18, or 20 to identify the digital media selection and other related play features, such as premium play, immediate play, etc. For example, a text message of S AB123 can be input by a user through the communication device 16, 18 or 20. The first character, labels S, by example only, is the type of media content. By example only S identifies a song. V would identify a video. PS would identify a priority play of a selected song. PV would identify a priority play of a video. The characters AB identify the location of the local jukebox 14. The alphanumeric characters 123 identify a particular media selection, such as a particular song. This information is obtainable from a list provided to the user at the local jukebox 14 venue.

These signals are transmitted to the SMSC where the user ID is validated. The location of the A/V playback device 14, media selection, and play feature data are transmitted from the SMSC to the MMM 24 by hard wire and/or wireless communication or combinations of both. The MMM 24 receives the selection information from the SMSC and communicates with the database 50 to determine the availability of the selected content and the selected A/V devices 14. When the MMM 24 has verified the corresponding A/V device 14 is operating and available to play the selected digital media, the MMM 24 sends a signal to the SMSC to bill the user for the SMS message including any premium play billing. The SMSC may then request a third party, such as, but not limited to, a bank, a credit card company, a mobile operator, etc., to debit the user account for the amount of the services procured. Other methods of payment may include m-wallet (mobile wallet), prepaid cards etc.

The MMM 24 can also communicate directly with a bank, credit card company or mobile operator to perform billing procedures without directly contacting the SMSC.

The MMM 24 can also communicate directly with a bank, credit card company or mobile operator to perform billing procedures without directly contacting the SMSC.

The user's communication device, namely, the user's mobile telephone 16, PDA 18 or even the user's desktop or laptop computer 20 can be provided with an application (hereafter “app”) which replaces the functionality of the SMS message sent by the user to the MMM 24.

The user can open the app and then press or click a button in the app which corresponds to a selection of a song or video to play at a particular location. The app creates a message using established protocols, such as SOAP, xml over http, http posts, etc., that has the LMS code or ID in the song code, such as S AB 1234. The tcp-ip address of the MMM 24 is well known to the app. The app then forwards the message to the MMM 24 directly over the wireless communication link, such as the wireless Internet link using established transmission formats, such as 4G, lte, 3G, Edge, GPRS, etc.

Upon receipt of the message from user's app, the MMM 24 creates a reply to the user which may contain text, images, etc., using the tcp-ip address of the user's mobile device to acknowledge receipt of the song selection, and other information as described above. The MMM 24 then forwards this reply to the user's app for viewing by the user.

At the same time, the MMM 24 sends the user request along with play criteria, such as a standard, recommendation or priority request, to a location media server, (LMS) coupled to the selected A/V device 14. This communication is via the Internet 12 to the selected A/V device 14 to implement the digital media selection at any premium or standard schedule.

It will be noted that the transmission of the digital media selection signals from the MMM 24 to the LMS and the selected A/V device 14 can also include the entire selected digital media, or simply a signal to the A/V device 14 to play a particular digital media already stored in the memory of the selected venue A/V device 14 or its LMS.

The MMM is also capable of sending a message through the SMSC to the user 16 thanking the user for making the selection. This will confirm that the selection has been implemented. At the same time, the message to the user 16 can include other messages, such as an offer to buy the selected song or video at a particular price or the ability to purchase or download as wall paper the user 16 pictures of the artist performing the selected song or performing in the selected video.

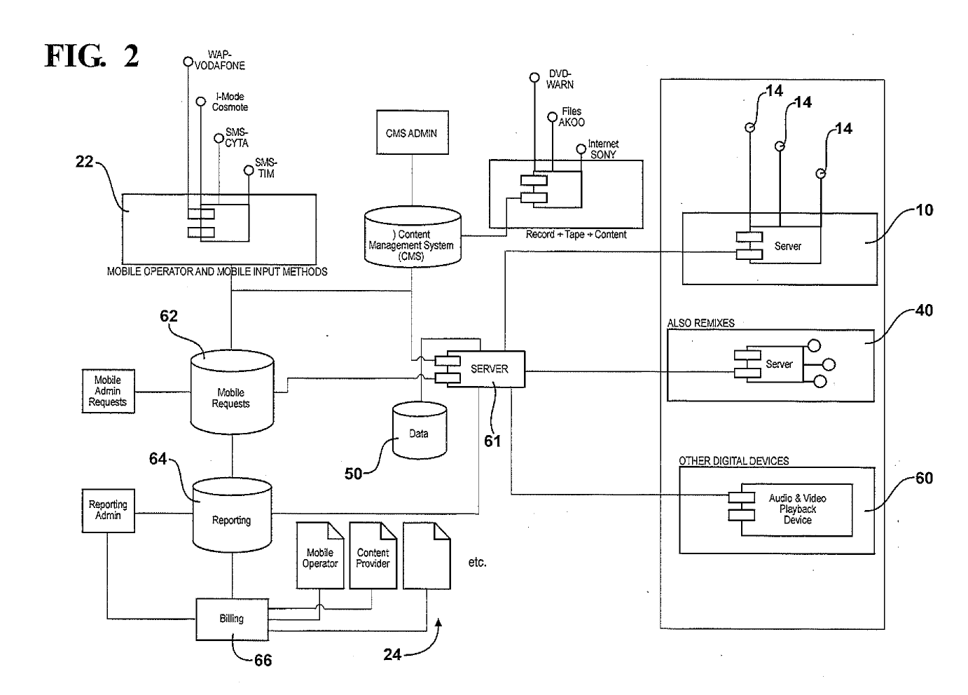

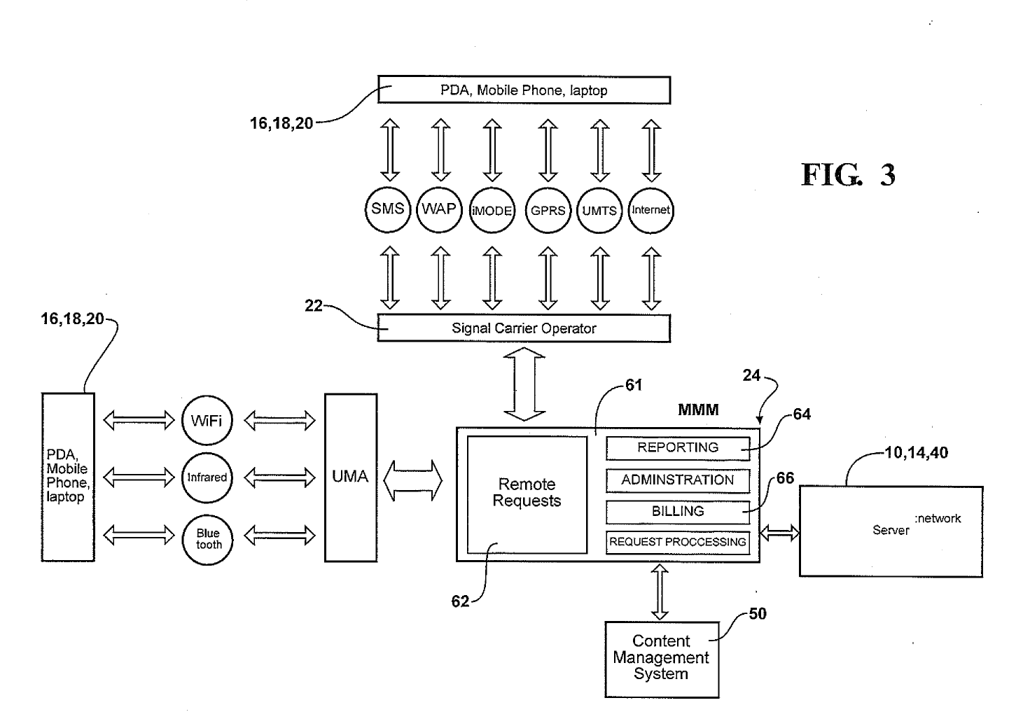

FIGS. 2 and 3 depict a block diagram of the major components of the control means or mobile media manager 24 used with any of the different aspects shown in FIGS. 1-3. The MMM 24 includes a so-called m-Venue server 61 which communicates with the music server 10, any of the seamless A/V devices 40 as well as other audio and video playback devices 60.

FIG. 3 also depicts the transmission or communication of digital media selection signals from the user interfaces or devices 16, 18 and 20 through the signal carrier network 22 as described above in conjunction with FIG. 1, through the Internet 12 as shown in conjunction with FIG. 3 or directly to a digital A/V device 14. The MMM 24, as described above, can receive a remote content or digital medial selection signal from any source. The MMM 24 then checks the selection for validity, processes it, stores it in a database, and forwards the request to the network server 10 in the aspect shown in FIG. 1 or directly to the jukebox 14 in other aspects.

The server 10 or A/V device 14 receives the A/V device signal from the MMM 24 and tries to place the request to the A/V device 14, etc. If this is successful, the server 10 then replies with a success message to the waiting MMM 24. If for any reason the is a failure in the request process, such as the A/V device 14 not responding, the transmission network is down, etc., the server 1 replies to the MMM 24 with a failure message along with the reason of the failure. Once the MMM has received an answer to the remote content selection signal, the MMM 24 records the answer in the database and informs the user with the result of his request.

A user request from any of the mobile user interface devices 16, 18 and 20 is communicated through the network 22 to a mobile request control means 62. The user request is then communicated to the m-Venue server 61 for digital content selection at a specific digital audio-visual playback device 14, etc., or in the A/V device music server 10 which transmits the digital media selection to the individual A/V device 14, etc., or from the content database 50 which is then transmitted by the MMM 24 directly to the A/V device 14, etc.

An example of a device or a system that can be used as a basis for implementing the system and functionality described herein on the server 61 is a computing device or computer. The computer can be any suitable computer or computing device. As an example, the computer can include one or more processors, such as a central processing unit (CPU) and memory, such as RAM memory and ROM memory. A storage device can be optionally provided in the form of any suitable computer readable medium, such as a hard disc drive. One or more input devices such as a keyboard and mouse, a touch screen interface, etc., allow input to be provided to the CPU. The display, such as liquid crystal display (LCD) or a cathode-ray tube (CRT) allows input to be presented to the user. A communication that is operable to send and receive data or other signals using the networks 12 or 22.

Each user request is also forwarded to a reporting module 64 which is in communication with the m-Venue server 61 to record each user request and the validation of a successful digital selection. The reporting module 64 communicates with a billing module 66 which suggests the fee for each user request.

The MMM 24 can also send only a signal to the LMS, such as LMS 140, 142, or 144, each coupled to one or more A/V devices 14, and/or send a command to one of the LMSs 140, 142, or 144, with three shown by way of example only in FIG. 1, in the form of a command to one particular LMS, such as LMS 140, to play the user selected digital media on one particular A/V device 14 coupled to the selected LMS 140, as well as to play the selected digital media and identifying the location of the selected digital media. The location of the selected digital media can be in the content database 50. In this case, the selected LMS 140 can communicate through the MMM 24 to the content database 50 to extract the complete selected digital media which is then transferred through the MMM 24 and the Internet 12 to the selected LMS 140.

Alternately, the MMM 24 can extract the digital media identified in the user request and transmit the entire selected digital media to any of the LMS's 140, 142 and 144.

As also shown in FIG. 1, a streaming audio-video server 60, embodied in the form of a computing device having a processor executing a stored controlled program stored in a memory coupled to the processor, is itself coupled in wireless, hardwire or combinations thereof communication with the master MMM 24, as well as the Internet 12. The streaming audio-video server (SANS) 60 contains A/V software which converts the digital format of a selected digital media in the content database 50 identified in a user request into a streaming audio-video format. This streaming A/V format can be specific to the particular A/V device 14 identified in the user request.

The SAYS 60 is capable, upon receiving a command from the master MMM 24, to retrieve a selected digital media identified in the user request from the content database 50, convert the digital media to streaming A/V format and then transfer the streaming A/V stream directly through the Internet 12 to the identified LMS 140, 142, or 144 and then to the selected A/V device 14 or back to the MMM 24 for transfer to the LMSs and A/V device 14.

The master MMM 24 and the streaming audio-video server 60 can also be combined into a single computing device or server having the combined functionality of both separate devices.

The LMS 140, 142 and 144 can be embodied in a server which can be any suitable computing device having a central processor executing a control program stored in a memory, either formed as part of the LMS or separate from, but disposed in communication with the processor of the LMS 140.

As will become more apparent hereafter, each LMS 140, 142 and 144 has an A/V output hardwired or coupled in wireless communication with the one or more A/V units 14 associated with a particular LMS, such as LMS 140. The A/V output is capable of converting the digital content received from the content database 50 in accordance with the user selection to audio video signals which can be played by the A/V unit 14.

Referring back to FIG. 1, a user request is transmitted at least in part through a wireless carrier network 22 to a global media management controller or MMM 24. The MMM 24 is disposed in communication by hardwire or wireless or combinations thereof transmission to a media content database 50 containing individual selectable digital media.

The MMM 24 is coupled through the Internet 12 to at least one location media server or LMS 200. The LMS 200 can be a physical or virtual computing device located in a data center which can be the same or separate and remote from the physical location of the MMM 24. For example, the LMS 200 may be embodied in a set top box located in a person's home.

The difference between a physical LMS and a virtual LMS is based on the hardware coupling between the LMS and its associated A/V device. In both a physical LMS and virtual LMS, the streaming A/V output stream is performed by audio visual player software executed in the LMS. A physical LMS has the A/V player software executed directly in the LMS hardware or server. A virtual LMS has the LMS functionality and the A/V player software executed on a server without any A/V output devices directly connected to the server. Instead, the A/V player software streaming the video to the A/V output device is coupled between the server running the virtual LMS software and the A/V device by the Internet in suitable formats, such as tcp/ip, udp, etc.

The A/V player software can be specific to a particular type of A/V device. Thus, the virtual LMS will have A/V specific software executed in its server for streaming the A/V media to the specific A/V device.

The A/V signals output by a physical LMS can be either an analog signal or digital signal recording to HDMI, SCART, VGA, SVIDEO, etc.

The A/V stream output of a virtual LMS is a binary stream of encoded video in a suitable format, such as xvid, mpeg4, avi, mov, raw, etc., formats. These formats are similar to the video files that typically reside in a computer.

A virtual LMS will also know the identifier or address of the specific A/V device to which it will stream the A/V output. Similarly, each A/V device employed with a virtual LMS will also know from its installed software the identifier of which virtual LMS it needs to connect it via the Internet to get the A/V stream.

By way of example only, the master MMM 24 communicates through the Internet 12 to a plurality of LMSs, including LMSs 200, 202, 204, 206, 208 and 210.

It will be understood that any number of LMSs 200-210 may be employed with a single MMM 24.

It will be understood that although the following description of the LMSs 200-210 describes such LMSs as virtual LMSs, any one of the LMSs 200-210 could be a physical LMS which, as described above, is directly coupled to one or more A/V devices 14. As shown in FIG. 1, a physical LMS 211 is coupled through the network 198 with virtual LMSs 206, 208 and 210. It will be understood that the physical LMS 211, in which the functional software of the LMS is executed by a processor in a separate server or computing device, can also be a stand-alone LMS without any interconnectivity with the virtual LMS's 206, 208 and 210.

The physical LMS 211 is directly coupled, such as by hardwired, wireless connections, or combinations of both, to at least one or a plurality of A/V devices, with two A/V devices 212 and 213 being shown in FIG. 1 by way of example only.

In the case of virtual LMSs, any of the LMSs 200-210 maybe embodied in software in a server, either in the same data center as the MMM 24, or in a data center separate and remote from the MMM 24. Further, two or more of the LMSs 200-210 may be embodied in the same server located in a single data center. Alternately, each of the LMSs 200-210 may be embodied in separate servers located in separate data centers or at separate locations.

The communication path from the master MMM 24 through the Internet 12 to the LMSs 200-210 uses the Internet which allows the MMM 24 to communicate directly with each individual LMS 200-210.

A plurality of audio-visual or A/V devices 222, 224, 226, 228, 230 and 232, 234, 236, 238, 240, 242, and 244, with the number of A/V devices being described and illustrated by way of example only, are individually selectable. The A/V devices 202 can be so called “smart” devices where each includes a processor, either in the form of a microcontroller, microprocessor, or other computer component capable of executed stored program instructions. Each processor in each A/V device 222-244 can be coupled to its own memory for storing data, digital media and the program instructions. For example, any A/V 222-242 can be a smart A/V, such as a tablet computer, i.e., iPad, a smartphone, i.e. iPhone, and Internet compatible television or Inet, video game console etc.

Any number of A/V devices, such as one or more A/V devices 14, can be coupled and controlled by a single LMS. For example, A/V devices 222 and 224 are coupled to the LMS 200. Similarly, the A/V devices 226 and 228 are coupled to the LMS 202.

Some or all of the A/V devices 200-242 may have different operating characteristics and may require different communication protocols. It can be difficult to provide one LMS 200 with sufficient capability to interact and communicate with each different type of A/V device 222-242. To overcome this hurdle, at least one and, for example, the plurality of virtual location media server s 200-210 can each include different A/V device software to enable the virtual LMSs to stream the A/V output to the specific A/V device in the format which can be acted on by the specific A/V device to generate the streaming A/V output.

Each virtual LMS 200-210 is embodied in a computer readable medium executed by a processor in a server or other computing device to provide the same functions as the physical LMS 200. However, each individual LMS 200-210 can have its program instructions tailored to the particular A/V devices with which it is coupled in data communication.

LMS 200 maybe, for example, a virtual LMS associated with one particular user where the user has two distinct A/V devices which are capable of displaying or playing digital audio/visual media. The request from the same user is transmitted through the carrier network 22 to the MMM 24. The MMM 24 determines the appropriate LMS for transmission of the digital media, which can be sent as a complete block of data or in a continuous stream. The MMM 24 forwards the media content identified by the user from the database 50 through the Internet 12 to the LMS 200 which is coupled to one specific A/V device contained in the user request. The request from the user contains an ID code for a specific A/V device 222 or 224. A subsequent request from the same user for the same digital media may simply switch the A/V device to which the media is sent or streamed to a different A/V device associated with the LMS 200, such as A/V device 224. This provides flexibility to each user to control and switch the selected digital media content to an appropriate A/V device on which the user wishes to see a selected media.

It is also possible to modify the LMS configuration shown in FIG. 1 by introducing a physical LMS between the Internet 112 and the LMS network 198. The physical LMS, not shown in FIG. 1, can thereby function to select which virtual LMS 200-210 is associated with the specific A/V device, such as A/V device 222, contained in the user request for the display of the selected media content. The physical LMS will utilize the network 198 to communicate independently with each virtual LMS 200-210.

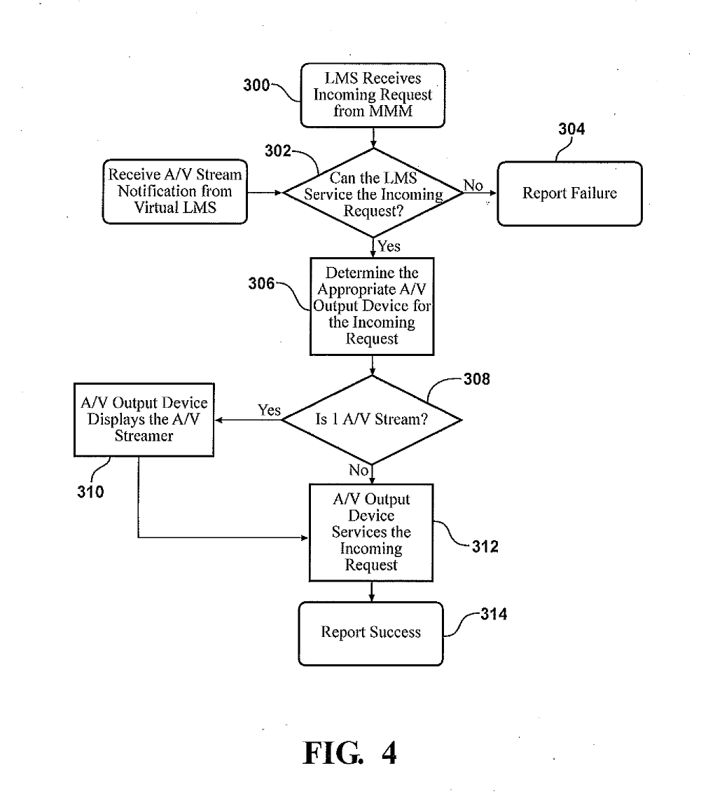

FIG. 4 depicts a flow chart of program control where, as described above, one, LMS, such as LMS 200, receives the incoming user request from the MMM 24 in step 300.

Next, in step 302, the LMS 200 determines whether or not it can service the incoming request. If not, a default or report failure sequence is entered in step 304. If, however, the LMS 200 can service the incoming request, the LMS 200 in step 306 determines the appropriate A/V output device specified in the incoming request.

Next, in step 308, the LMS 200 determines if the selected media content is an A/V stream. If the media is an A/V stream, the stream is forwarded by the LMS 200 to the selected A/V device 222 in step 310 so that the A/V device 222 displays the A/V stream.

If the selected media forwarded from the MMM 24 to LMS 200 is not an A/V stream, the media is forwarded in step 312 to the selected A/V device which can service the incoming user request. Either at the beginning of the data stream or the transfer of data to the selected A/V device or at the completion of the A/V stream or play of the selected digital media, a report is generated in step 314 to the user and/or the manager of the MMM 24 of a successful media transfer.

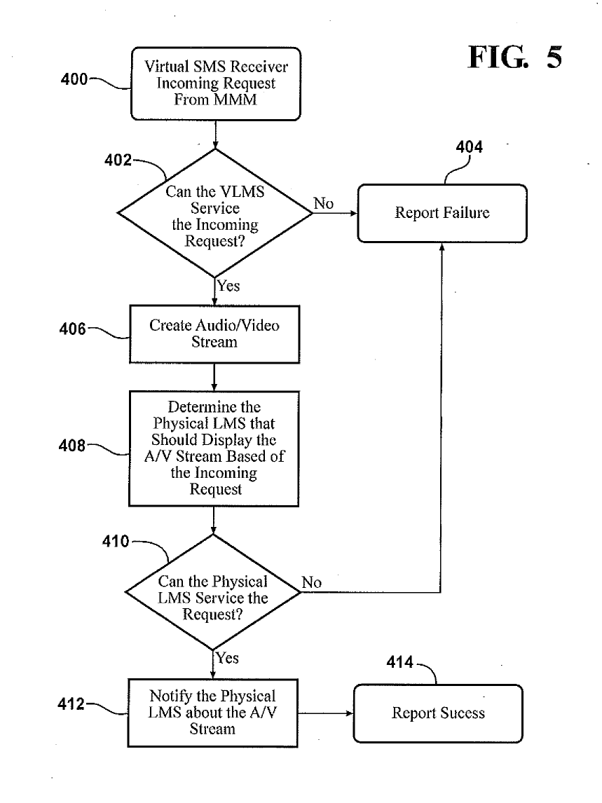

FIG. 5 depicts and alternate flow sequence where one of the virtual LMSs 202-210 receives an incoming user request through the LMS 200 from the MMM 24 in step 400. In this flow sequence, the virtual LMS which received the incoming user request from the MMM 24 determines if it can service the incoming request in step 402. If not, the default report failure sequence is initiated in step 404.

If the receiving LMS can service the incoming user request, the LMS creates an audio/video stream in step 406. The receiving LMS then determines in step 408 which should display the A/V stream as specified in the incoming user request. The virtual LMS then determines in step 410 whether it can service the user request. If no, the default or report failure sequence is entered in step 404. If yes, the virtual LMS notifies the initial LMS that received the request in step 412 about the A/V stream and then reports successful A/V stream transfer in step 414 to the MMM 24 for user billing, reporting the successful media transfer to the user, record keeping, etc.

1. A method for media content selection and play comprising the steps of:
receiving, by a master media manager controller, a user request requesting a specific media for play on a specified audio-visual playback device;
accessing by the master media manager controller a store of media content;
providing at least one virtual location media server in communication with the master media controller, the at least one virtual location media server residing in a computer readable medium of a computing device;
disposing at least one audio-visual device in communication with the at least one virtual location media server; and
transmitting the identified digital media by the master media controller through the at least one location media server to the selected at least one audio-visual device for play of the media in the user request by the selected at least one audio-visual device.

2. The method of claim 1 further comprising:
providing a plurality of virtual location media servers; and
at least one audio-visual device disposed in communication with each virtual location media server.

3. The method of claim 2 further comprising the step of:
configuring each of the virtual location media servers for receiving a user request.

4. The method of claim 3 further comprising:
determining by the one of the virtual location media servers that receives an incoming user request if the receiving location media server can service the user request;
if yes, the receiving one location media server determining the availability of the virtual location media server disposed in communication with the selected a least one A/V device identified on the user request; and
if yes, the one receiving location media server forwarding the media content specified in the user request to the selected at least one A/V device.

5. The method of claim 1 further comprising:
coupling a streaming audio-video server in communication with the master media manager controller and each of the virtual media manager controllers; and
executing, by the streaming audio-video server, a stored controlled program for converting a digital format media to a streaming audio-video signal.

6. The method of claim 5 further comprising:
coupling the streaming audio-video server in communication with the Internet for transferring a streaming audio-video signal to a selected one of the location media servers for play on a selected audio-video device.

7. An apparatus for media content selection and play comprising:
means for receiving, by a master media manager controller, a user request requesting a specific digital media for play on one audio-visual playback device;
means for accessing by the master media manage controller a store of media content;
means for providing at least one virtual location media server in communication with the media manager controller, the at least one virtual location media server residing in a computer readable medium of a computing device;
means for disposing at least one audio-visual device in communication with the at least one virtual location media server; and
means for transmitting the digital media by the master media manager controller through the at least one location media server to the selected at least one audio-visual device for play of the digital media in the user request by the selected audio-visual device.

8. An apparatus for digital content selection and play comprising:
at least one audio-visual playback device capable of playing digital audio-visual media, the audio-visual playback device having a distinct identifier;
a master media manager controller configured for receiving a user request from a user interface separate from the at least one audio-visual playback device, the user request identifying a distinct audio-visual media content and the distinct identifier of the at least one audio-visual playback device;
at least one virtual media manager controller embodied in a computer executable medium in a computing device coupled to the master media manager controller; and
the at least one virtual media manager controller coupled by a first communication path with the at least one location media server for transferring media content to the at least one audio-visual playback device.

9. The apparatus of claim 8 further comprising:
the at least one virtual location media server including a plurality of virtual location media servers; and
independently communicating by the master media manager controller with each of the plurality of virtual location media servers.

10. The apparatus of claim 9 further comprising:
the at least one of the virtual location media server coupled to a plurality of audio-visual playback devices.

11. The apparatus of claim 8 further comprising:
a streaming audio-video server coupled in communication with the master media manager controller and each of the virtual media manager controllers; and
the streaming audio-video server executing a stored controlled program for converting a digital format media to a streaming audio-video signal.

12. The apparatus of claim 11 further comprising:
the streaming audio-video server coupled in communication with the Internet for transferring a streaming audio-video signal to a selected one of the location media servers for play on a selected audio-video device.
